(19) United States
(12) Patent Application Publication
(10) Pub. No.: US 2002/0048997 A1
(43) Pub. Date: Apr. 25, 2002

(54) Connecting block with staggered IDCs

(76) Inventor: John A. Siemon, Woodbury, CT (US)

Correspondence Address: CANTOR COLBURN, LLP, 55 GRIFFIN ROAD SOUTH, BLOOMFIELD, CT, 06002

(21) Appl. No.: 09/576,829

(22) Filed: May 23, 2000

Related U.S. Application Data
(60) Provisional application No. 60/156,780, filed on Sep. 30, 1999.

(51) Int. Cl. H01R 4/24

(52) U.S. Cl. 439/625

(57) ABSTRACT

A connecting block with a plurality of staggered pairs of Insulative Displacement Contacts (IDCs) for terminating pairs of wires is provided. The connecting block comprises a molded plastic housing and can accommodate a two-pair or four-pair IDC configuration. The pairs of IDCs are positioned in multiple staggered rows for the purpose of minimizing crosstalk.

### CROSS REFERENCE TO RELATED APPLICATIONS

This application claims the benefit of U.S. provisional application Ser. No. 60/156,780 filed Sep. 30, 1999, the entire contents of which are incorporated herein by reference.

### BACKGROUND OF THE INVENTION

Current 110 type connecting systems provide a flexible means of connecting or cross-connecting horizontal and backbone wiring within a building to either end-user equipment or communications networking. The 110 type connecting systems are designed to support digital data transmission as well as analog/digital voice over unshielded twisted pair (UTP) media through the use of wiring blocks, connecting blocks and patch cords or jumpers.

The connecting blocks employed utilize punch down Insulation Displacement Contacts (IDCs) to maximize density and ease of use. The conventional block system comprises IDCs that are aligned in a single row. As the rate of transmission increases within the system, radiation levels increase as well, causing near end crosstalk between IDC pairs. This crosstalk is not problematic when transmission occurs at low frequencies (around 16 Mhz), however, as the rate of transmission increases up to 400 Mhz the higher radiation levels produce a greater incidence of crosstalk. To reduce this crosstalk, connecting blocks have been developed utilizing conductive shields (plates) between adjacent pairs of IDCs.

### SUMMARY OF THE INVENTION

The connecting block system of this invention includes a molded plastic housing which contains a number of conductive Insulation Displacement Contacts (IDCs) positioned in multiple staggered rows.

### BRIEF DESCRIPTION OF THE DRAWINGS

Referring now to the drawings wherein like elements are numbered alike in the several Figures:

FIGS. 1A through 1F represent a first embodiment illustrating IDC pairs staggered upon two axes.

FIGS. 2A through 2F represent a second embodiment illustrating IDCs staggered within each pair upon three axes.

FIGS. 3A through 3F represent a third embodiment illustrating IDCs staggered within each pair upon four axes.

FIGS. 4A through 4F represent a fourth embodiment illustrating IDC pairs which are angled and staggered upon two axes.

FIG. 5 represents an isometric view of a 110 type wiring block (or base) compatible for use with the connecting block set forth in FIGS. 1A through 1F.

### DETAILED DESCRIPTION OF THE PREFERRED EMBODIMENTS

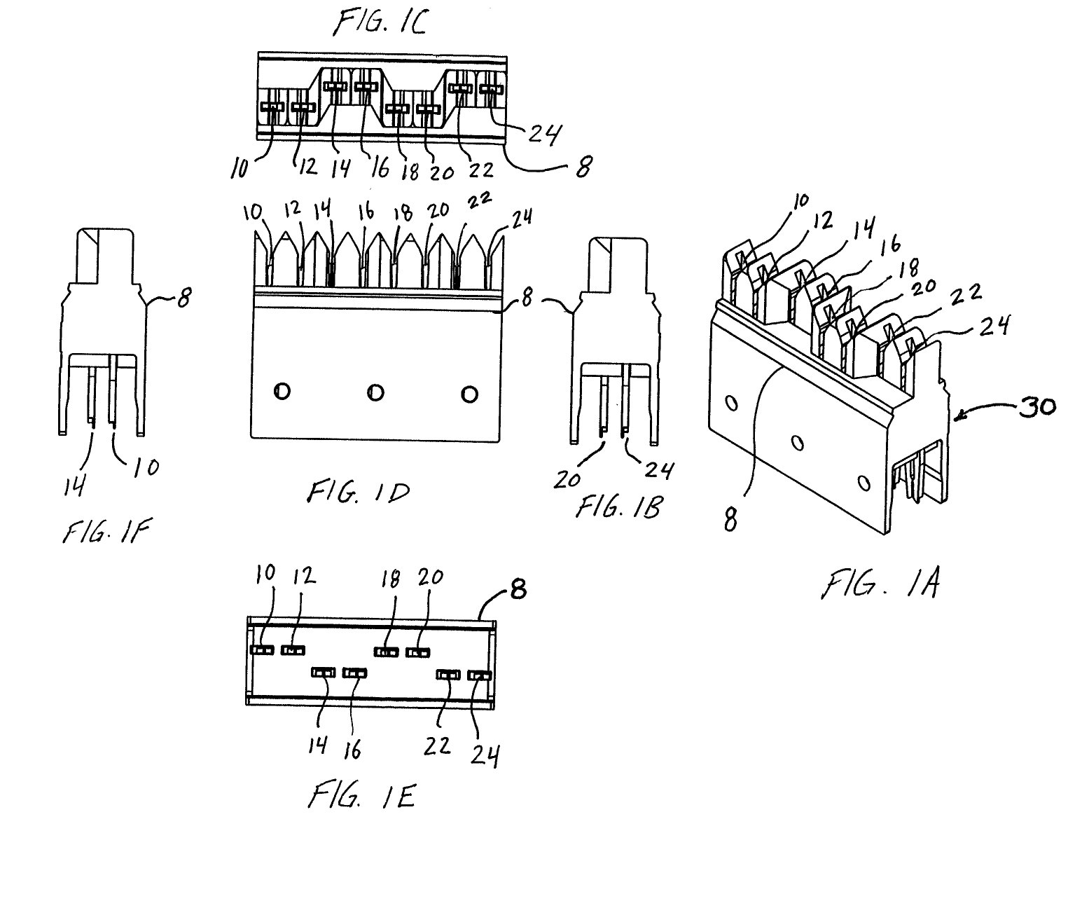

Referring to FIGS. 1A through 1F, an exemplary embodiment of the present invention includes a connecting block shown generally at 30, wherein 8 IDCs are paired and staggered along 2 axes. FIG. 1A is an isometric view of the connecting block 30. FIGS. 1B, 1C, 1D, 1E and 1F, are front, top, side, bottom and rear views, respectively, of the connecting block 30. It will be appreciated that FIGS. 1A, 1C, 1D, and 1E depict connecting block 30 with a plurality of IDCs numbered 10, 12, 14, 16, 18, 20, 22, and 24, while FIGS. 1B and 1F depict only IDCs numbered 20, 24 and 14, 10 respectively. Each IDC in said connecting block comprises a pair of insulation penetrating contacts for terminating a pair of wires. IDCs 10 and 12 are paired and used for terminating a first pair of tip and ring wires. IDCs 14 and 16 are paired and used for terminating a second pair of tip and ring wires. IDCs 18 and 20 are paired and used for terminating a third pair of tip and ring wires. IDCs 22 and 24 are paired and used for terminating a fourth pair of tip and ring wires.

Referring to FIGS. 1A through 1F, IDCs 10, 12, 18, and 20 are aligned on a first axis. The first axis is a first distance from edge 8. IDCs 14, 16, 22, and 24 are aligned on a second axis. The second axis is a second distance from edge 8. The first and second axes are linear and parallel. It is understood that the location of the first and second axes need not be referenced from only edge 8. Any reference on the connecting block may be used to indicate the position of the first axis and the second axis.

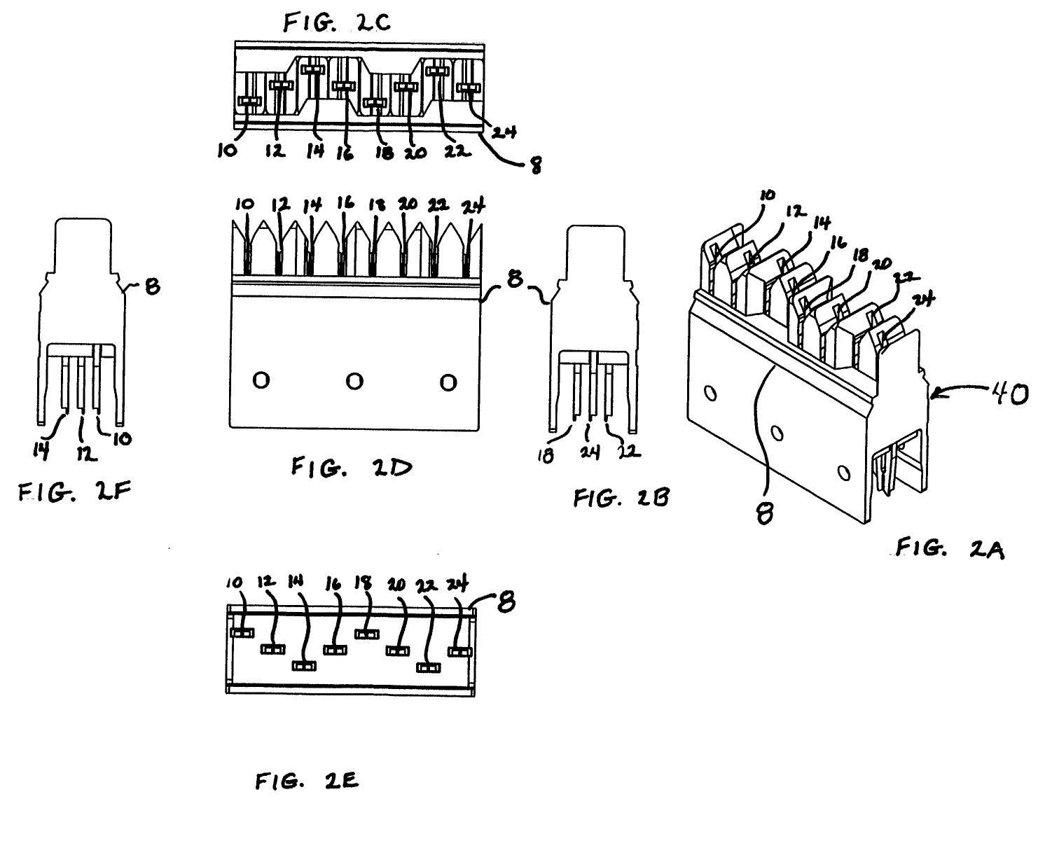

FIGS. 2A through 2F illustrate a second embodiment of a connecting block shown generally at 40, wherein 8 IDCs are staggered within pairs and upon 3 different axes. FIG. 2A is an isometric view of the connecting block 40. FIGS. 2B, 2C, 2D, 2E and 2F, are front, top, side, bottom and rear views, respectively, of the connecting block 40. It will be appreciated that FIGS. 2A, 2C, 2D, and 2E depict connecting block 40 with a plurality of IDCs numbered 10, 12, 14, 16, 18, 20, 22, and 24, while FIGS. 2B and 2F depict only IDCs numbered 18, 24, 22 and 14, 12, 10 respectively. Each IDC in said connecting block 40 comprises a pair of insulation penetrating contacts for terminating a pair of wires. IDCs 10 and 12 are paired and used for terminating a first pair of tip and ring wires. IDCs 14 and 16 are paired and used for terminating a second pair of tip and ring wires. IDCs 18 and 20 are paired and used for terminating a third pair of tip and ring wires. IDCs 22 and 24 are paired and used for terminating a fourth pair of tip and ring wires.

Referring to FIGS. 2A through 2F, IDCs 10 and 18 are aligned on a first axis. The first axis is a first distance from edge 8. IDCs 12, 16, 20, and 24 are aligned on a second axis. The second axis is a second distance from edge 8. IDCs 14 and 22 are aligned on a third axis. The third axis is a third distance from edge 8. The first, second and third axes are linear and parallel. It is understood that the location of the first, second and third axes need not be referenced from only edge 8. Any reference on the connecting block may be used to indicate the position of the first, second and third axes.

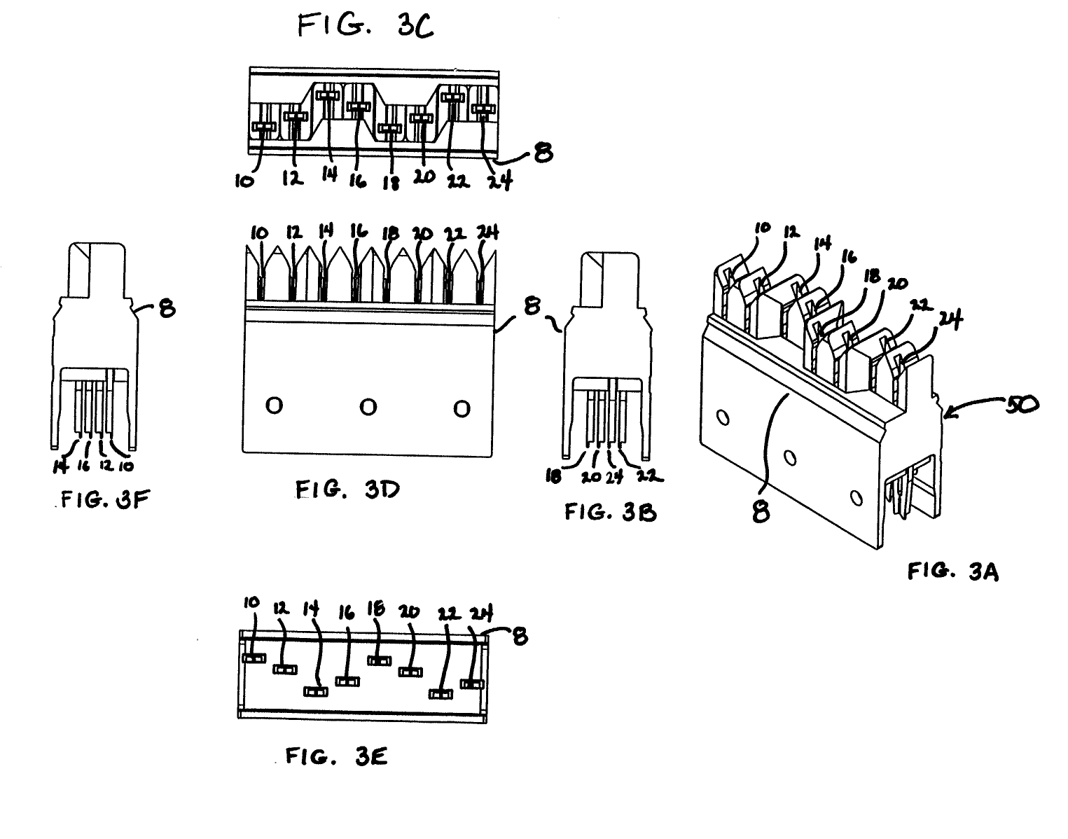

FIGS. 3A through 3F illustrate a third embodiment of a connecting block shown generally at 50 wherein 8 IDCs are staggered within pairs and aligned on four axes. FIG. 3A is an isometric view of the connecting block 50. FIGS. 3B, 3C, 3D, 3E and 3F, are front, top, side, bottom and rear views, respectively, of the connecting block 50. It will be appreciated Siemon that FIGS. 3A, 3C, 3D, and 3E depict a connecting block 50 with a plurality of IDCs numbered 10, 12, 14, 16, 18, 20, 22, and 24, while FIGS. 3B and 3F depict only IDCs numbered 18, 20, 24, 22 and 14, 16, 12, 10 respectively. Each IDC in said connecting block 50 comprises a pair of insulation penetrating contacts for terminating a pair of wires. IDCs 10 and 12 are paired and used for terminating a first pair of tip and ring wires. IDCs 14 and 16 are paired and used for terminating a second pair of tip and ring wires. IDCs 18 and 20 are paired and used for terminating a third pair of tip and ring wires. IDCs 22 and 24 are paired and used for terminating a fourth pair of tip and ring wires.

Referring to FIGS. 3A through 3F, IDCs 10 and 18 are aligned on a first axis. The first axis is a first distance from edge 8. IDCs 12 and 20 are aligned on a second axis. The second axis is a second distance from edge 8. IDCs 14 and 22 are aligned on a third axis. The third axis is a third distance from edge 8. IDCs 16 and 24 are aligned on a fourth axis. The fourth axis is a fourth distance from edge 8. The first, second, third and fourth axes are linear and parallel. It is understood that the location of the first, second, third and fourth axes need not be referenced from only edge 8. Any reference on the connecting block may be used to indicate the position of the first, second, third and fourth axes.

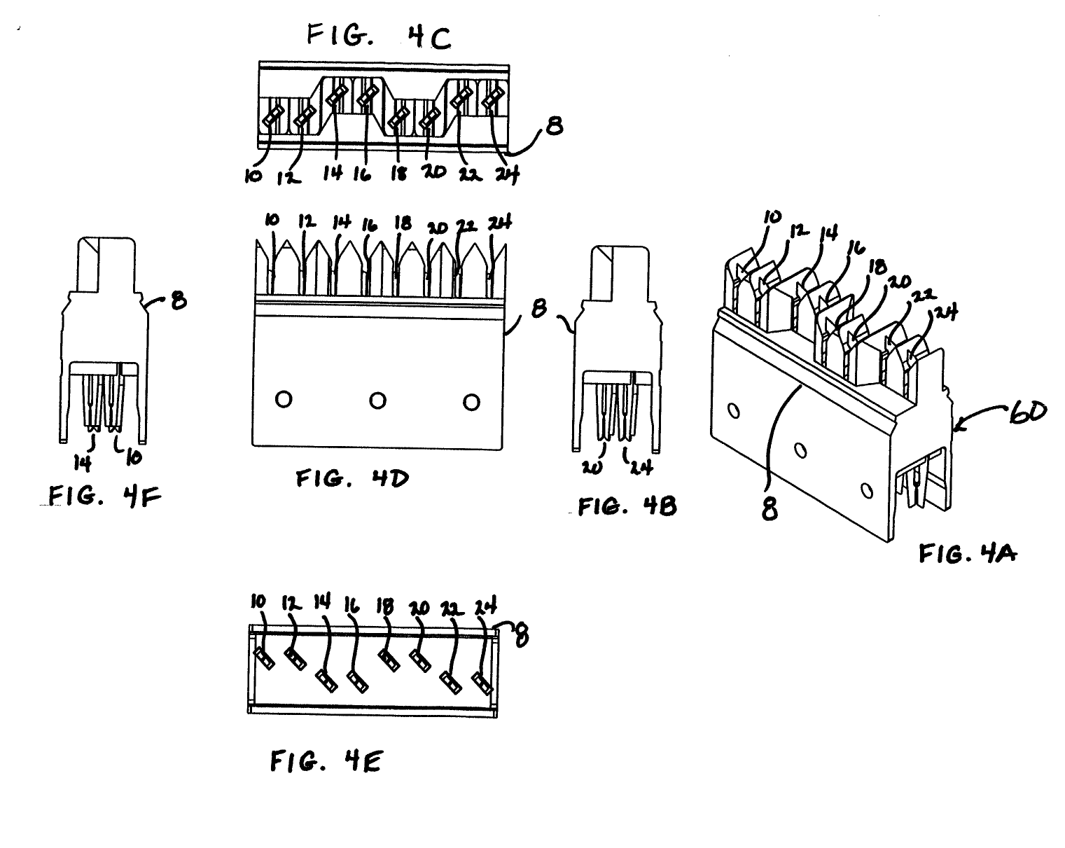

FIGS. 4A through 4F illustrate a fourth embodiment of a connecting block shown generally at 60 wherein 8 IDCs are paired and staggered upon two axes. Each IDC is angled with respect to a corresponding axis. FIG. 4A is an isometric view of the connecting block 60. FIGS. 4B, 4C, 4D, 4E and 4F, are front, top, side, bottom and rear views, respectively, of the connecting block 60. It will be appreciated that FIGS. 4A, 4C, 4D, and 4E depict Siemon connecting block 60 with a plurality of IDCs numbered 10, 12, 14, 16, 18, 20, 22, and 24, while FIGS. 4B and 4F depict only IDCs numbered 24, 20 and 14, 10 respectively. Each IDC in said connecting block 60 comprises a pair of insulation penetrating contacts for terminating a pair of wires. IDCs 10 and 12 are paired and used for terminating a first pair of tip and ring wires. IDCs 14 and 16 are paired and used for terminating a second pair of tip and ring wires. IDCs 18 and 20 are paired and used for terminating a third pair of tip and ring wires. IDCs 22 and 24 are paired and used for terminating a fourth pair of rip and ring wires.

Referring to FIGS. 4A through 4F, IDCs 10, 12, 18, and 20 are aligned on a first axis and angled with respect to the first axis. The first axis is a first distance from edge 8. IDCs 14, 16, 22, and 24 are aligned on a second axis angled with respect to the second axis. The second axis is a second distance from edge 8. It is understood that the location of the first and second axes need not be referenced from only edge 8. Any reference on the connecting block may be used to indicate the position of the first axis and the second axis.

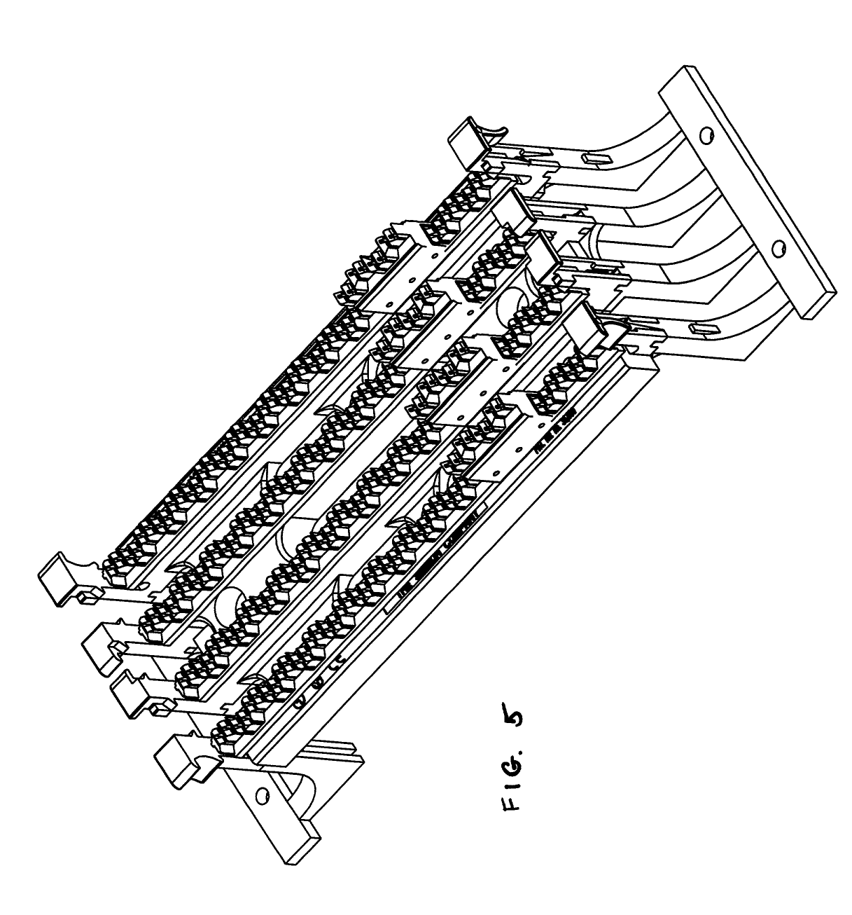

FIG. 5 represents an isometric view of a wiring block with four connecting blocks that utilize the configuration set forth in FIGS. 1A through 1F above.

As the present invention is directed to improvements in the location of connecting block IDCs, the details of the connecting block are not fully disclosed in the drawings and description herein. Such details are known in the art as provided, for example, in U.S. Pat. No. 4,964,812.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A connecting block comprising:
a housing having a first edge;
a pair of first and second insulation penetrating contacts in said housing for terminating a first pair of wires; wherein said first and second insulation penetrating contacts are aligned on a first axis in said housing; and
a pair of third and fourth insulation penetrating contacts in said housing for terminating a second pair of wires; wherein said third and fourth insulation penetrating contacts are aligned on a second axis in said housing.

2. The connecting block of claim 1, further comprising:
a pair of fifth and sixth insulation penetrating contacts in said housing for terminating a third pair of wires; wherein said fifth and sixth insulation penetrating contacts are aligned on said first axis in said housing.

3. The connecting block of claim 2, further comprising:
a pair of seventh and eighth insulation penetrating contacts in said housing for terminating a fourth pair of wires; wherein said seventh and eighth insulation penetrating contacts are aligned on said second axis in said housing.

4. The connecting block of claim 1, wherein said first axis is a first distance from said first edge of said connecting block and said second axis is a second distance from said first edge of said connecting block.

5. The connecting block of claim 1, wherein said first axis and said second axis are parallel.

6. A connecting block comprising:
a housing having a first edge;
a pair of first and second insulation penetrating contacts in said housing for terminating a first pair of wires; wherein said first insulation penetrating contact is aligned on a first axis in said housing and said second insulation penetrating contact is aligned on a second axis in said housing; and
a pair of third and fourth insulation penetrating contacts in said housing for terminating a second pair of wires; wherein said third insulation penetrating contact is aligned on a third axis in said housing and said fourth insulation penetrating contact is aligned on said second axis in said housing.

7. The connecting block of claim 6, further comprising:
a pair of fifth and sixth insulation penetrating contacts in said housing for terminating a third pair of wires; wherein said fifth insulation penetrating contact is aligned on said first axis in said housing and said sixth insulation penetrating contact is aligned on said second axis in said housing.

8. The connecting block of claim 7, further comprising:
a pair of seventh and eighth insulation penetrating contacts in said housing for terminating a fourth pair of wires; wherein said seventh insulation penetrating contact is aligned on said third axis in said housing and said eighth insulation penetrating contact is aligned on a second axis in said housing.

9. The connecting block of claim 6, wherein:
said first axis is a first distance from said first edge of said housing, said second axis is a second distance from said first edge of said housing, and said third axis is a third distance from said first edge of said housing.

10. The connecting block of claim 6 wherein said first axis, said second axis and said third axis are parallel.

11. A connecting block, comprising:
a housing having a first edge;
a pair of first and second insulation penetrating contacts in said housing for terminating a first pair of wires; wherein said first insulation penetrating contact is aligned on a first axis in said housing and said second insulation penetrating contact is aligned on a second axis in said housing; and
a pair of third and fourth insulation penetrating contacts in said housing for terminating a second pair of wires; wherein said third insulation penetrating contact is aligned on a fourth axis in said housing and said fourth insulation penetrating contact is aligned on a third axis in said housing.

12. The connecting block of claim 11, further comprising:
a pair of fifth and sixth insulation penetrating contacts in said housing for terminating a third pair of wires; wherein said fifth insulation penetrating contact is aligned on said first axis in said housing, and said sixth insulation penetrating contact is aligned on said second axis in said housing.

13. The connecting block of claim 12, further comprising:
a pair of seventh and eighth insulation penetrating contacts in said housing for terminating a fourth pair of wires; wherein said seventh insulation penetrating contact is aligned on a fourth axis in said housing, and said eighth insulation penetrating contact is aligned on a third axis in said housing.

14. The connecting block of claim 11, wherein:
said first axis is a first distance from said first edge of said housing, said second axis is a second distance from said first edge of said housing, said third axis is a third distance from said first edge of said housing, and said fourth axis is a fourth distance from said first edge of said housing.

15. The connecting block of claim 11 wherein said first axis, said second axis, said third axis and said fourth axis are parallel.

16. A connecting block comprising:
a housing having a first edge;
a pair of first and second insulation penetrating contacts in said housing for terminating a first pair of wires; wherein said first and second insulation penetrating contacts are:
aligned on a first axis in said housing, and are angled with respect to said first axis; and
a pair of third and fourth insulation penetrating contacts in said housing for terminating a second pair of wires; wherein said third and fourth insulation penetrating contacts are:
aligned on a second axis in said housing, and are angled with respect to said second axis.

17. The connecting block of claim 16, further comprising:
a pair of fifth and sixth insulation penetrating contacts in said housing for terminating a third pair of wires; wherein said fifth and sixth insulation penetrating contacts are:
aligned on said first axis in said housing, and are angled with respect to said first axis.

18. The connecting block of claim 17, further comprising:
a pair of seventh and eighth insulating penetrating contacts in said housing for terminating a fourth pair of wires; wherein said seventh and eighth insulation penetrating contacts are:
aligned on a second axis in said housing, and are angled with respect to said second axis.

19. The connecting block of claim 16 wherein said first axis is a first distance from said first edge of said connecting block, and said second axis is a second distance from said first edge of said connecting block.

20. The connecting block of claim 16 wherein said first and second axes are parallel.
